(19) United States
(12) Patent Application Publication
(10) Pub. No.: US 2022/0136675 A1
(43) Pub. Date: May 5, 2022

(54) LIGHT SOURCE STRUCTURE, BACKLIGHT MODULE AND DISPLAY DEVICE

(71) Applicants: Radiant(Guangzhou) Opto-Electronics Co., Ltd, Guangdong (CN); Radiant Opto-Electronics Corporation, KAOHSIUNG (TW)

(72) Inventors: Jui-Lin CHEN, KAOHSIUNG (TW); Pin-Hsun LEE, KAOHSIUNG (TW); Yuan-Jhang CHEN, KAOHSIUNG (TW)

(21) Appl. No.: 17/577,036

(22) Filed: Jan. 17, 2022

Related U.S. Application Data
(63) Continuation of application No. PCT/CN2020/123347, filed on Oct. 23, 2020.

(51) Int. Cl. F21V 3/00

(52) U.S. Cl. CPC F21V 3/00

(57) ABSTRACT

A light source structure, a backlight module and a display device are described, in which the light source structure includes a substrate, plural partition walls, plural light-emitting units and plural package structures. The plural partition walls are disposed on the substrate so as to form plural accommodating spaces. The light-emitting units are disposed on the substrate and are located in the accommodating spaces. The package structures are filled in the accommodating spaces and cover the light-emitting units. A height of each package structure is smaller or equal to a height of each partition wall, and the height of each of the package structures which is located near a side portion of the substrate is smaller than the heights of the partition walls which are located near a center portion of the substrate.

### RELATED APPLICATIONS

This application is a continuation application of International Application No. PCT/CN2020/123347 filed on Oct. 23, 2020, which is incorporated herein by reference.

### BACKGROUND

### Field of Invention

The present disclosure relates to a light source element. More particularly, the present disclosure relates to a light source structure, a backlight module, and a display device.

### Description of Related Art

Generally, a light source used in a direct type backlight module mainly includes a substrate, a plurality of light-emitting diodes arranged on a substrate, and an encapsulant covering on the light-emitting diodes. The light generated from the light-emitting diodes may further be mixed by an optical film to form a surface light source.

However, since for the light-emitting diodes disposed near the edge of the substrate, there are insufficient numbers of adjacent light-emitting diodes, dark edges will be generated due to the lack of the light at the location near the edge of the entire light source. This will seriously impact the appearance and the uniformity of the backlight module and the display device.

### SUMMARY

Accordingly, an objective of the present disclosure is to provide a light source structure, a backlight module, and a display device, in which by using the design of the light source structure, the situation that dark edges appeared on the backlight module and the display device effects the appearance may be avoided.

According to the aforementioned objectives of the present disclosure, a light source structure is provided. The light source structure comprises a substrate, a sidewall, a plurality of light-emitting units, and at least one package structure. The sidewall stands on an edge portion of the substrate, wherein there is at least one accommodating space between the substrate and the sidewall. The light-emitting units are disposed on the substrate and located in the accommodating space. The package structure is filled in the accommodating space and covers the light-emitting units. A height of the package structure is smaller than or equal to a height of the sidewall, and the height of the package structure near the edge portion of the substrate is smaller than the height of the package structure near a central portion of the substrate.

According to one embodiment of the present disclosure, the aforementioned light source structure further comprises a plurality of partition walls disposed on the substrate and located at inner side of the sidewall. Wherein the number of the accommodating space is plural, and the accommodating spaces are separated by the sidewalls. Wherein the number of the package structure is plural, and the package structures are disposed respectively in the accommodating spaces, and the height of each of the package structures is smaller than or equal to the height of each of the partition walls.

According to one embodiment of the present disclosure, wherein the heights of the package structures in the accommodating spaces gradually decrease with increased distance between each of the accommodating spaces and the central portion of the substrate.

According to one embodiment of the present disclosure, wherein decreasing ranges of the heights of the package structures is not more than 30%, including an end point value.

According to one embodiment of the present disclosure, wherein the package structure in each of the accommodating spaces near the edge portion of the substrate has a decreasing portion.

According to one embodiment of the present disclosure, wherein a plurality of microstructures are disposed at a surface of each of the decreasing portions.

According to one embodiment of the present disclosure, wherein there is a gap existing between a top surface of the package structure in each of the accommodating spaces near the edge portion of the substrate and a top surface of each of the partition walls.

According to one embodiment of the present disclosure, wherein a reflectance of each of the partition walls is higher than reflectances of the package structures.

According to one embodiment of the present disclosure, wherein the package structure has a decreasing portion near the edge portion of the substrate, and decreasing ranges of the decreasing portion is not more than 30%, including an end point value.

According to one embodiment of the present disclosure, wherein there are a plurality of microstructures disposed at the surface of the package structure near the edge portion of the substrate.

According to one embodiment of the present disclosure, another backlight module is provided. This backlight module comprises the aforementioned light source structure and at least an optical film. The optical film is disposed on the sidewall, wherein there is an air gap existing between at least one optical film and a top surface of at least one portion of the package structures.

According to one embodiment of the present disclosure, another display device is provided. This display device comprises the aforementioned backlight module and a display panel. The display panel is disposed on the backlight module.

According to the embodiments of the present disclosure, it is known that the light source structure of the present disclosure mainly changes the filled height of the package structures to adjust the luminance of emitted light of light-emitting units, thereby improving the dark region occurred on the edge and the non-uniformity of emitted light of the conventional backlight module. It may not only enhance the uniformity of emitted light of the entire backlight module and display device, but also reduce the using of the encapsulant.

### BRIEF DESCRIPTION OF THE DRAWINGS

To illustrate more clearly, the aforementioned and the other objectives, features, merits, and embodiments of the present invention, the description of the accompanying figures are as follows:

FIG. 1 schematically shows a side view of a direct type backlight module in accordance with a first embodiment of the present disclosure.

FIG. 2 schematically shows a side view of a direct type backlight module in accordance with a second embodiment of the present disclosure.

FIG. 3 schematically shows a side view of a direct type backlight module in accordance with a third embodiment of the present disclosure.

FIG. 4 schematically shows a side view of a direct type backlight module in accordance with a fourth embodiment of the present disclosure.

FIG. 5 schematically shows a side view of a direct type backlight module in accordance with a fifth embodiment of the present disclosure.

FIG. 6 shows a simulation diagram of luminances generated by the light source structure of the first embodiment and a conventional light source structure.

FIG. 7 schematically shows a side view of a display device in accordance with an embodiment of the present disclosure.

### DETAILED DESCRIPTION

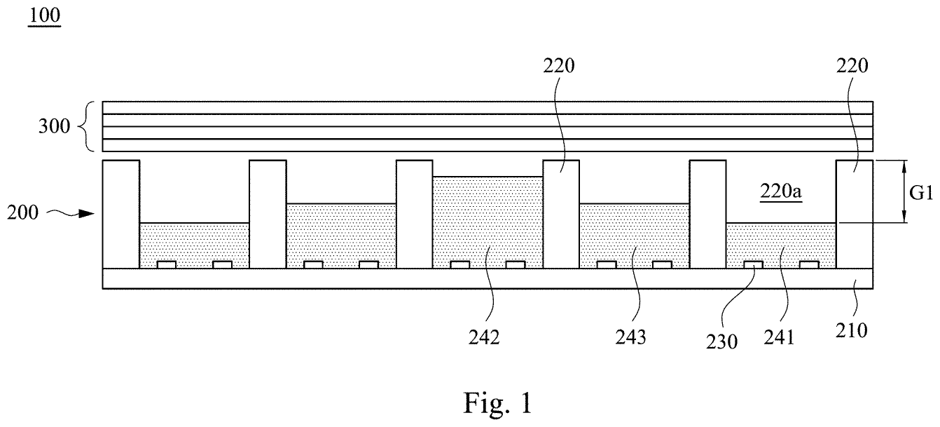

Referring to FIG. 1, FIG. 1 schematically shows a side view of a direct type backlight module in accordance with a first embodiment of the present disclosure. The backlight module 100 of the present embodiment comprises a light source structure 200 and at least one optical film (for example four optical films 300). The optical films 300 are disposed on the light source structure 200, therefore the light generated by the light source structure 200 may pass through the optical films 300 and emit outward from the optical films 300.

Referring to FIG. 1 again, the light source structure 200 includes a substrate 210, plural partition walls 220, plural light-emitting units 230, and plural package structures (for example, a package structure 241, a package structure 242, and a package structure 243). The partition walls 220 are disposed on the substrate 210 so as to form plural accommodating spaces 220a, in which the partition wall 220 closet to an edge portion of the substrate 210 substantially functions as a sidewall. The light-emitting units 230 are disposed on the substrate 210 and in the accommodating spaces 220a. In the present embodiment, there are, but not limited to, four light-emitting units 230 disposed in each of the accommodating spaces 220a. In other embodiments, the number of light-emitting units 230 in each of the accommodating spaces 220a depends on requirements. In an embodiment, the light-emitting units may be blue LEDs.

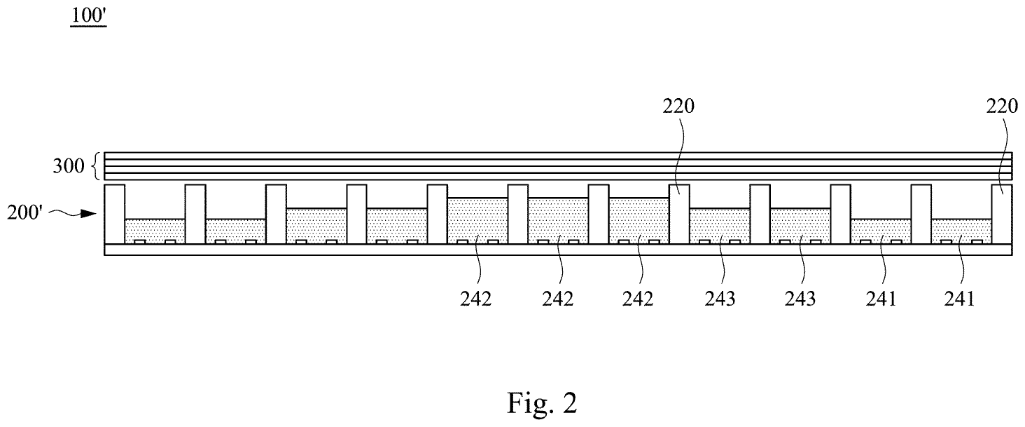

As shown in FIG. 1, the package structure 241, the package structure 242, and the package structure 243 are filled in the accommodating spaces 220a and cover the light-emitting units 230. In an embodiment, the height of the package structure 241, the height of the package structure 242, and the height of the package structure 243 are not lower than the height of the light-emitting units 230, so that the light produced by the light-emitting units 230 may be mixed inside the package structures and emit outward. Therefore, the color of emitted light of the backlight module of the present disclosure may be ensured to be more uniform. It is noted that, the package structure 241, the package structure 242, and the package structure 243 substantially are the same structure. To explain the structure design of the present disclosure conveniently, the package structure 241 is used to represent a package structure near the edge portion of the substrate 210; the package structure 242 is used to represent a package structure near a central portion of the substrate 210; and the package structure 243 is used to represent a package structure between the package structure 241 and the package structure 242. In the present disclosure, the height of each of the package structures (for example, the package structure 241, the package structure 242, and the package structure 243) is smaller than or equal to the height of each of the partition walls 220, and the height of the package structure 241 near the edge portion of the substrate 210 is smaller than the height of the package structure 242 near the central portion of the substrate 210. In the present embodiment, the heights of the package structures in the accommodating spaces 220a gradually decrease along a direction from the location near the central portion of the substrate 210 to the location away from the substrate 210 (that is, near the edge portion of the substrate 210). In other embodiments, the numbers of the package structure 241, the package structure 241, and the package structure 241 with different heights are not limited to be one. For example, as shown in FIG. 2, FIG. 2 schematically shows a side view of a direct type backlight module 100′ in accordance with a second embodiment of the present disclosure. In the backlight module 100′ as shown in the FIG. 2, there are plural package structures 241 with the same height disposed at the edge portion of a light source structure 200′, plural package structures 242 with the same height disposed at the central portion, and plural package structures 243 with the same height disposed between package structures 241 and the package structures 242.

In an embodiment (for example, the embodiment of FIG. 1), decreasing ranges of the height of any two of the adjacent package structures with different heights are not more than 30%, including an end point value. As shown in FIG. 1, when the decreasing ranges of the heights of any two of the adjacent package structures with different heights are more than 30%, it will lead to excessive difference of the luminance between the light emitted from the adjacent package structures, which will easily cause the problem of non-uniformity of emitted light and poor optical taste.

As shown in FIG. 2, FIG. 2 takes any two of the adjacent package structures with different heights as an example, the height of a package region (multiple package structures 242) near the central portion of the substrate 210 is approximately 300 μm, the height of a package region (multiple package structures 241) near the edge portion of the substrate 210 is approximately 200 μm, the height of a package region (multiple package structures 243) between the package structure 242 and the package structure 241 may be 250 μm. In the same way, in the embodiment of FIG. 2, the decreasing ranges of the heights of any two of the adjacent package structures with different heights are not more than 30%, including the end point value. In one embodiment, transmittances of the package structures are higher than the transmittance of each of the partition walls 220, and the reflectance of each of the partition walls 220 is higher than the reflectances of the package structures (for example, the package structure 241, the package structure 241, and the package structure 241), therefore most of the light generated from the light-emitting unit 230 may pass through the package structures to reach the partition walls 220 and further be reflected out, thereby improving the utilization ratio of the light and the light emitting luminance.

Since the light transmittance of the package structure of the same material is a fixed value, a path of the light passing through the package structures may be shortened by reducing the thickness of the package structures, thereby increasing the quantity of emitted light. It may be seen that through the way of designing the height of the package structure 241 near the edge portion of the substrate 210 to be lower than the height of the package structure 242 near the central portion of the substrate 210 in the present disclosure, the luminance of emitted light passing through the package structure 241 near the edge portion of the substrate 210 may be higher than the luminance of emitted light passing through the package structure 242 near the central portion of the substrate 210, thereby improving the dark region at the edge portion and the non-uniformity of emitted light of the conventional direct type backlight module.

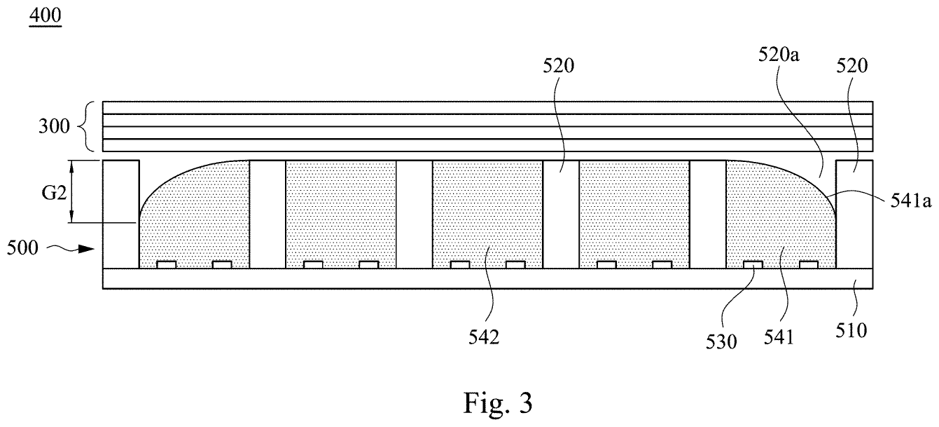

In the present disclosure, the light source structure may have different structural designs. Referring to FIG. 3, FIG. 3 schematically shows a side view of a direct type backlight module 400 in accordance with a third embodiment of the present disclosure. The structure of the backlight module 400 of the present embodiment is similar to the structure of the backlight module 100 shown in FIG. 1, and the main difference therebetween is that a light source structure 500 of the backlight module 400 has a different structural design. As shown in FIG. 3, the backlight module includes the light source structure 500 and at least one optical film (for example, four optical films 300). The optical films are disposed on the light source structure 500, therefore the light generated from the light source structure 500 may pass through the optical films 300 and be emitted outward from the optical films 300.

Referring to FIG. 3 again, the light source structure 500 includes a substrate 510, plural partition walls 520, plural light-emitting units 530, and plural package structures (for example, package structures 541 and package structures 542). The partition walls 520 are disposed on the substrate 510, and plural accommodating spaces 520a are formed between the partition walls 520 and the substrate 510. The light-emitting units are disposed on the substrate 510, and are located in the accommodating spaces 520a. In the present embodiment, there are four light-emitting units 530 disposed in each of the accommodating spaces 520a.

As shown in FIG. 3, the package structures 541 and the package structures 542 are filled in the accommodating spaces 520a, and cover the light-emitting units 530. It is noted that, the package structure 541 and the package structure 542 substantially are the same structure. To explain the structure design of the present disclosure conveniently, the package structure 541 is used to represent a package structure near the edge portion of the substrate 510; the package structure 542 is used to represent a package structure away from the edge portion of the substrate 510. In the present embodiment, the height of each of the package structures (for example, the package structure 541 and the package structure 542) is smaller than or equal to the height of each of the partition walls 520, and the height of the package structure 541 near the edge portion of the substrate 510 is smaller than the height of the package structure 542 away from the edge portion of the substrate 510. In the present embodiment, each of the package structures 541 in the accommodating spaces 520a near the edge portion of the substrate 510 has a decreasing portion 541a, and the height of the decreasing portion 541a gradually decreases from one end near the central portion of the substrate 510 to the other end away from the central portion of the substrate 510.

In an embodiment, a decreasing range of the height of the package structure 541 is not more than 30%, including the end point value. In a concrete embodiment, the filled height of the package structure 542 away from the edge portion of the substrate 510 may be aligned with the top surface of the partition walls 520, and the height of the package structure 541 located at the edge portion of the substrate 510 gradually decreases from the central portion of the substrate 510 to the edge portion of the substrate 510. Since the light transmittance of the package structure of the same material is a fixed value, a path of the light passing through the package structures may be shortened by reducing the thickness of the package structures, thereby increasing the quantity of emitted light. By designing the package structure 541 located at the edge portion of the substrate 510 with height-decreasing design, the brightness of the light emitted from a lower region of the package structure 541 is increased, thereby improving the dark region at the edge portion and the non-uniformity of emitted light of the conventional direct type backlight module.

In other embodiments, the transmittance of the package structures is higher than the transmittance of each of the partition walls 520, and the reflectance of each of the partition walls 520 is higher than the reflectances of the package structures (for example, the package structure 541 and package structure 542), therefore most of the light generated from the light-emitting unit 530 may pass through the package structures to reach the partition walls 520 and further be reflected out, thereby improving the utilization ratio of the light and the light emitting luminance.

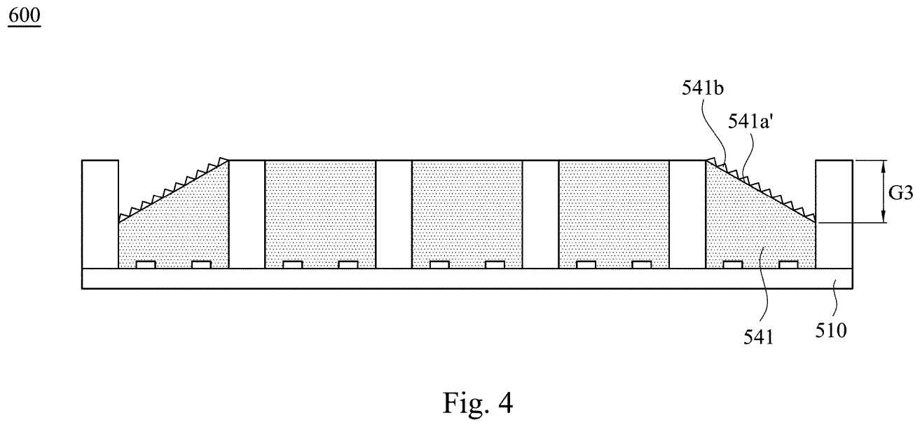

In the embodiment of FIG. 3, the surface of the decreasing portion 541a of the package structure 541 is a smooth surface and is a convex surface. In other embodiments, the surface of the decreasing portion may also be designed to be an inclined plane, a concave surface, or a surface having microstructures. For example, as shown in FIG. 4, FIG. 4 schematically shows a side view of a direct type backlight module 600 in accordance with a fourth embodiment of the present disclosure. The structure of the light source structure 600 as shown in the FIG. 4 is similar to that of the light source structure 500 as shown in the FIG. 3, the main difference therebetween is that a decreasing portion 541a′ of the package structure 541 near the edge portion of the substrate 510 in the light source structure 600 has a different structural design. In the embodiment of FIG. 4, the surface of the decreasing portion 541a′ is an inclined plane, and there are microstructures 541b disposed on the surface of the decreasing portion 541a′, thereby directing more light out from the surface of the decreasing portion 541a′, and further solving problems of the dark region at the edge portion and the non-uniformity of emitted light of the conventional direct type backlight module. In the present embodiment, each of the microstructures 541b may be a concave or convex dotted structure, a hair structure, or a lenticular structure.

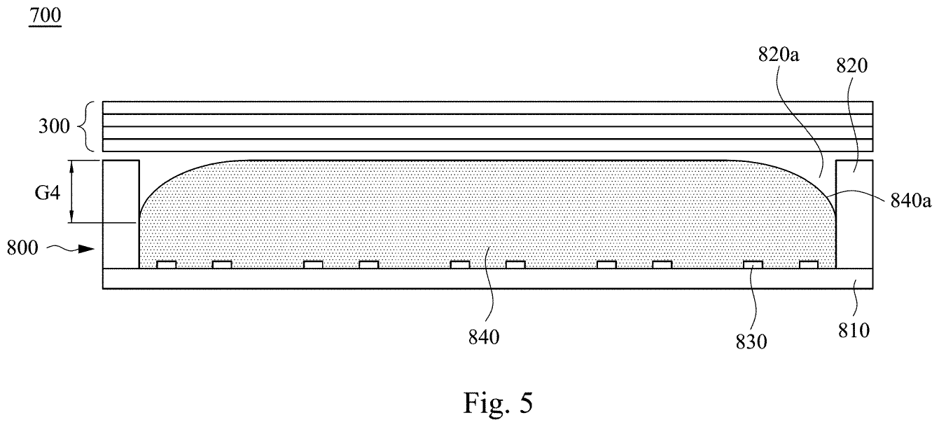

In the aforementioned embodiments (for example, the embodiments of FIG. 1 to FIG. 4), the light source structure includes multiple partition walls, and multiple accommodating spaces are separated multiple partition walls. In other embodiments, the light source structure may be also designed to have no partition walls. For example, as shown in FIG. 5, FIG. 5 schematically shows a side view of a direct type backlight module 700 in accordance with a fifth embodiment of the present disclosure. The structure of the backlight module 700 as shown in the FIG. 5 is similar to that of the backlight module 400 as shown in the FIG. 3, the main difference therebetween is that the backlight module 700 is void of partition walls. In the backlight module 700, the backlight module 700 includes a light source structure 800 and at least one optical film (for example, four optical films 300). The optical films are disposed on the light source structure 800, therefore the light generated from the light source structure 800 may pass through the optical films 300 and be emitted outward from the optical films 300.

Referring to FIG. 5 again, the light source structure 800 includes a substrate 810, sidewalls 820, plural light-emitting units 830, and a package structure 840. The sidewalls 820 are disposed on an edge portion of the substrate 810, and enclose to form an accommodating space 820a collectively with the substrate 810. The light-emitting units 830 are disposed on the substrate 810 and are located in the accommodating space 820a. The package structure 840 is filled in the accommodating space 820a, and covers the light-emitting units 830. In the present embodiment, the height of the package structure 840 is smaller than or equal to the height of the sidewalls 820, and the height of the package structure 840 near the edge portion of the substrate 810 is smaller than the height of the package structure 840 away from the edge portion of the substrate 810.

In the embodiment of FIG. 5, the package structure 840 covers the light-emitting units 830 as an integrated form, accordingly, the shape of the package structure 840 is corresponding to the shape of the space enclosed by the sidewalls 820. Taking the embodiment of FIG. 5 as an example, the sidewalls 820 form a quadrilateral space, and the package structure 840 is a quadrilateral form as well. The package structure 840 has a decreasing portion 840a near the edge portion of the substrate 810, and there is a single decreasing portion 840a in the embodiment of FIG. 5. Therefore, from the side view of FIG. 5, there are two decreasing portions 840a at the right side and the left side of FIG. 5, the height of the decreasing portion 840a gradually decreases from a location near the central portion of the substrate 810 to a location away from the central portion of the substrate 810, thereby increasing the quantity of emitted light from the location of the package structure 840 near the edge of the substrate 810, and solving problems of the dark region occurred at the edge portion and the non-uniformity of emitted light of the conventional backlight module. In other embodiments, the surface of the decreasing portion 840a may also be designed to be an inclined plane, a concave surface, or a surface having microstructures in order to achieve the same effect mentioned before, and hence is not repeated in detail herein.

It is noted that, in the aforementioned five embodiments, since the height of the package near the edge portion of the substrate is designed to be smaller than the height of the package structure near the central portion of the substrate, there is a gap existing between the top surface of the package structure near the edge portion of the substrate and the top surface of the partition walls (for example, the gap G1 of FIG. 1, the gap G2 of FIG. 3, the gap G3 of FIG. 4, and the gap G4 of FIG. 5). Accordingly, when the optical films cover on the light source structure and are loaded at the top surface of the partition walls of the light source structure, the optical films may at least form an air gap (that is, a layer of air) collectively with the top surface of the package structure near the edge portion of the substrate. This air gap (the layer of air) may scatter the light emitted from the surface of the package structure, so as to uniformize the light.

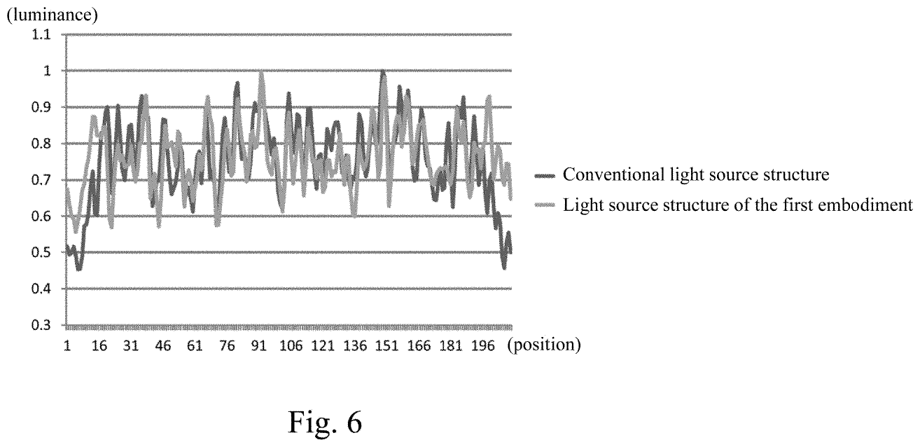

Referring to FIG. 1 and FIG. 6 simultaneously, in which FIG. 6 shows a simulation diagram of light intensity generated by the light source structure of the first embodiment and a conventional light source structure. In FIG. 6, a dark gray line represents the luminance generated by using the conventional light source structure, and the light gray line represents the luminance generated by using the light source structure 200 of the first embodiment of the present disclosure. As shown in FIG. 6, the luminance of emitted light near the edge portion of the conventional light source structure filled with the package structure without height variation is apparently lower than that of the light source structure 200 filled with the package structures with unequal heights of the first embodiment. In other words, by using the design that the height of the package structure near the edge portion of the substrate of the present disclosure is lower than the package structure near the central portion of the substrate, the luminance of emitted light near the edge portion of the light source structure and the entire uniformity may be apparently improved.

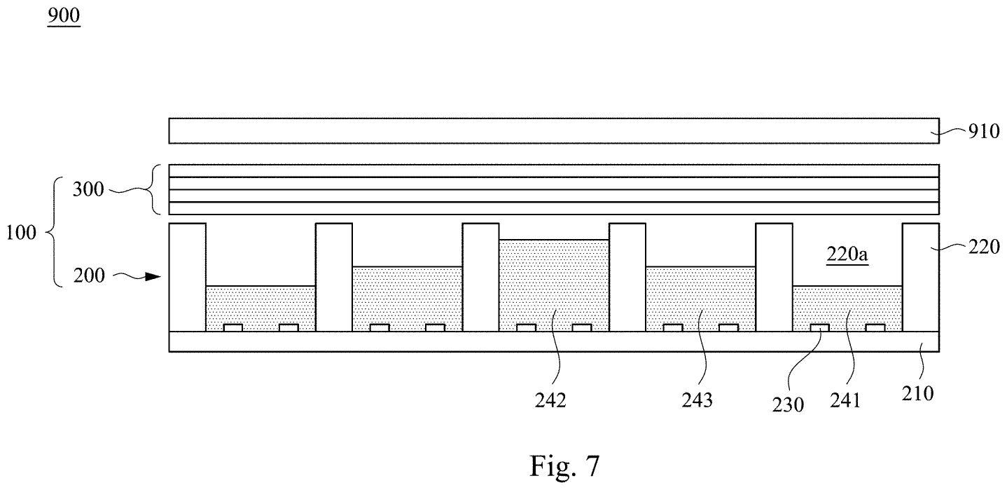

Referring to FIG. 7, FIG. 7 schematically shows a side view of a display device 900 in accordance with an embodiment of the present disclosure. The display device 900 of the present disclosure includes the backlight module 100 as shown in FIG. 1 and a display panel 910. As shown in FIG. 7, the display panel 910 is disposed on the optical films 300 of the backlight module 100. Through the design of the light source structure 200 in the backlight module 100, the display device can achieve the effect of light emitting uniformity without any dark edges, which will not be repeated again herein. It is noted that, the display device 900 applied to the backlight module 100 as FIG. 1 shown in the present disclosure is only used for exemplary description, and not for limiting the present invention. The backlight modules of other embodiments (for example, the backlight module 100 of FIG. 2, the backlight module 400 of FIG. 3, the backlight module 700 of FIG. 5), or the light source structure of the other embodiments (for example, the light source structure of FIG. 4) also can be applied in the display device in order to achieve the same effect.

According to the embodiments of the present disclosure, it is known that the light source structure of the present disclosure mainly changes the filled height of the package structures to adjust the luminance of emitted light of light-emitting units, thereby solving problems of the dark region occurred on the edge portion and the non-uniformity of emitted light of the conventional backlight module. It may not only enhance the uniformity of emitted light of the entire backlight module and display device, but also reduce the using of the encapsulant.

Even though the embodiments of the present disclosure are disclosed by the aforementioned embodiments, the aforementioned embodiments are not used for limiting the embodiments of the present disclosure. For any those skilled in the art, various modifications and variations may be made to the structure of the present invention without departing from the scope or spirit of the embodiments of the present disclosure, therefore, the protected scope of the embodiments of the present disclosure should be defined based on the following claims.

What is claimed is:

1. A light source structure, comprising:
a substrate;
a sidewall standing on an edge portion of the substrate, wherein there is at least one accommodating space between the substrate and the sidewall;
a plurality of light-emitting units disposed on the substrate and located in the accommodating space; and
at least one package structure filled in the accommodating space and covering the light-emitting units;
wherein a height of the package structure is smaller than or equal to a height of the sidewall, and the height of the package structure near the edge portion of the substrate is smaller than the height of the package structure near a central portion of the substrate.

2. The light source structure of claim 1, further comprising a plurality of partition walls disposed on the substrate and located at inner side of the sidewall,
wherein the number of the accommodating space is plural, and the accommodating spaces are separated by the sidewalls;
wherein the number of the package structure is plural, and the package structures are disposed respectively in the accommodating spaces, and the height of each of the package structures is smaller than or equal to the height of each of the partition walls.

3. The light source structure of claim 2, wherein the heights of the package structures in the accommodating spaces gradually decrease with increased distance between each of the accommodating spaces and the central portion of the substrate.

4. The light source structure of claim 3, wherein decreasing ranges of the heights of the package structures is not more than 30%, including an end point value.

5. The light source structure of claim 2, wherein the package structure in each of the accommodating spaces near the edge portion of the substrate has a decreasing portion.

6. The light source structure of claim 5, wherein a plurality of microstructures are disposed at a surface of each of the decreasing portions.

7. The light source structure of claim 2, wherein there is a gap existing between a top surface of the package structure in each of the accommodating spaces near the edge portion of the substrate and a top surface of each of the partition walls.

8. The light source structure of claim 2, wherein a reflectance of each of the partition walls is higher than reflectances of the package structures.

9. The light source structure of claim 1, wherein the package structure has a decreasing portion near the edge portion of the substrate, and decreasing ranges of the decreasing portion is not more than 30%, including an end point value.

10. The light source structure of claim 1, wherein there are a plurality of microstructures disposed at the surface of the package structure near the edge portion of the substrate.

11. A backlight module, comprising:
a light source structure of claim 1; and
at least one optical film disposed on the sidewall, wherein there is an air gap existing between the at least the one optical film and a top surface of at least one portion of the package structures.

12. A display device, comprising:
a backlight module of claim 11; and
a display panel disposed on the backlight module.
